(19) United States
(12) Patent Application Publication
(10) Pub. No.: US 2020/0092449 A1
(43) Pub. Date: Mar. 19, 2020

(54) DUAL CAMERA MODULE

(71) Applicant: Altek Semiconductor Corp., Hsinchu City (TW)

(72) Inventor: Jui-Hsin Chang, Hsinchu City (TW)

(73) Assignee: Altek Semiconductor Corp., Hsinchu City (TW)

(21) Appl. No.: 16/372,427

(22) Filed: Apr. 2, 2019

(30) Foreign Application Priority Data
Sep. 19, 2018 (TW) 107212735

(51) Int. Cl. H04N 5/225; G02B 13/00; G02B 7/02; G03B 17/12

(52) U.S. Cl. CPC H04N 5/2257; H04N 5/2254; G03B 17/12; G02B 7/02; G02B 13/001

(57) ABSTRACT

A dual camera module includes a first circuit board, a second circuit board, a first base, a first lens, a second base, a second lens and a glue. The second circuit board and the first circuit board are arranged side by side. The first base is disposed on the first circuit board, and the first lens is disposed inside the first base. The second base is disposed on the second circuit board, wherein the second base and the first base are arranged side by side, and a first outer surface of the first base faces a second outer surface of the second base. The second lens is disposed inside the second base. The glue is disposed between the first base and the second base and adhered to the first outer surface and the second outer surface.

### CROSS-REFERENCE TO RELATED APPLICATION

This application claims the priority benefit of Taiwan application serial no. 107212735, filed on Sep. 19, 2018. The entirety of the above-mentioned patent application is hereby incorporated by reference herein and made a part of this specification.

### BACKGROUND

### Field of the Invention

The invention is directed to a camera module and more particularly, to a dual camera module.

### Description of Related Art

A dual camera module has been widely introduced to a currently available terminal device, for example, a smart cell phone or other portable electronic devices, which is configured to implement functions, such as distance measuring, optical zooming, dark enhancement, 3D photography, 3D modeling and so on. Among them, special effect processing of images, such as background blurring, background replacement or others, can be further achieved based on the distance measuring function.

Generally, the dual camera module commonly requires a frame to fix two camera modules arranged side by side, thereby preventing the two camera modules from deviating from each other. Even though the two camera modules can be covered and fixed by the frame to improve reliability of use, the manufacturing cost is expensive. Second, for the terminal assembly, the currently available dual camera module occupies more disposition space inside the terminal device, which is unfavorable for the development of terminal device toward miniaturization.

### SUMMARY

The invention provides a dual camera module which has lower manufacturing cost and can contribute to the development of a terminal device toward miniaturization.

A dual camera module of the invention includes a first circuit board, a second circuit board, a first base, a first lens, a second base, a second lens and a glue. The second circuit board and the first circuit board are arranged side by side. The first base is disposed on the first circuit board, and the first lens is disposed inside the first base. The second base is disposed on the second circuit board, wherein the second base and the first base are arranged side by side, and a first outer surface of the first base faces a second outer surface of the second base. The second lens is disposed inside the second base. The glue is disposed between the first base and the second base and adhered to the first outer surface and the second outer surface.

In an embodiment of the invention, the dual camera module further includes a support disposed between the first lens and the second lens. The support has a first side surface and a second side surface opposite to each other, wherein the first side surface abuts against the first outer surface and the second side surface abuts against the second outer surface. The glue covers at least a part of the support.

In an embodiment of the invention, the first side surface of the support is disposed with at least one trench, and the trench faces the first outer surface. At least a part of the glue is filled in the trench and adhered to the first outer surface.

In an embodiment of the invention, the second side surface of the support is disposed with at least one trench, and the trench faces the second outer surface. At least a part of the glue is filled in the trench and adhered to the second outer surface.

In an embodiment of the invention, the support further has at least one trench located between the first side surface and the second side surface, and at least a part of the glue is filled in the trench.

In an embodiment of the invention, the support has a plurality of holes, and at least a part of the glue is filled in the holes.

In an embodiment of the invention, a gap between the first outer surface of the first base and the second outer surface of the second base is less than or equal to 12 millimeters (mm).

In an embodiment of the invention, the dual camera module further includes a first photosensitive element and a second photosensitive element. The first photosensitive element is disposed on the first circuit board, disposed inside the first base and located between the first lens and the first circuit board. The second photosensitive element is disposed on the second circuit board, disposed inside the second base and located between the second lens and the second circuit board.

To sum up, the dual camera module of the invention is a frameless dual camera module, in which two camera modules are adhered together by the glue to fix the relative position between the two camera modules, thereby preventing the relative position between the two lens modules from deviating. Thus, the dual camera module of the invention may not only have low manufacturing cost, but also contribute to the development of the terminal device toward miniaturization.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural diagram of a dual camera module according to a first embodiment of the invention.

FIG. 2 is a schematic cross-sectional diagram of the dual camera module depicted in FIG. 1 along line A-A.

FIG. 3 is a schematic structural diagram of a dual camera module according to a second embodiment of the invention.

FIG. 4 is a schematic cross-sectional diagram of the dual camera module depicted in FIG. 3 along line B-B.

FIG. 5 is a schematic cross-sectional diagram of a dual camera module according to a third embodiment of the invention.

### DESCRIPTION OF EMBODIMENTS

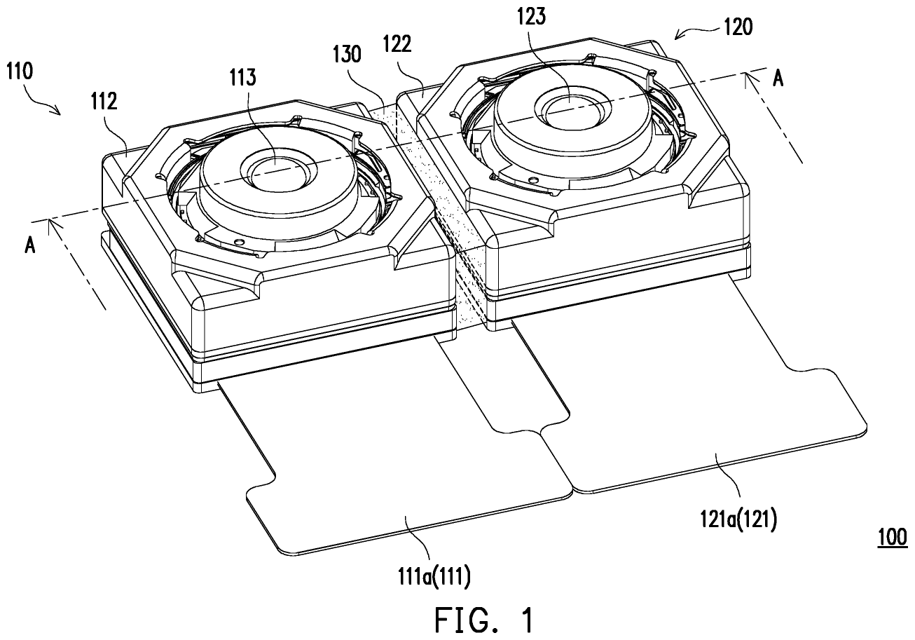

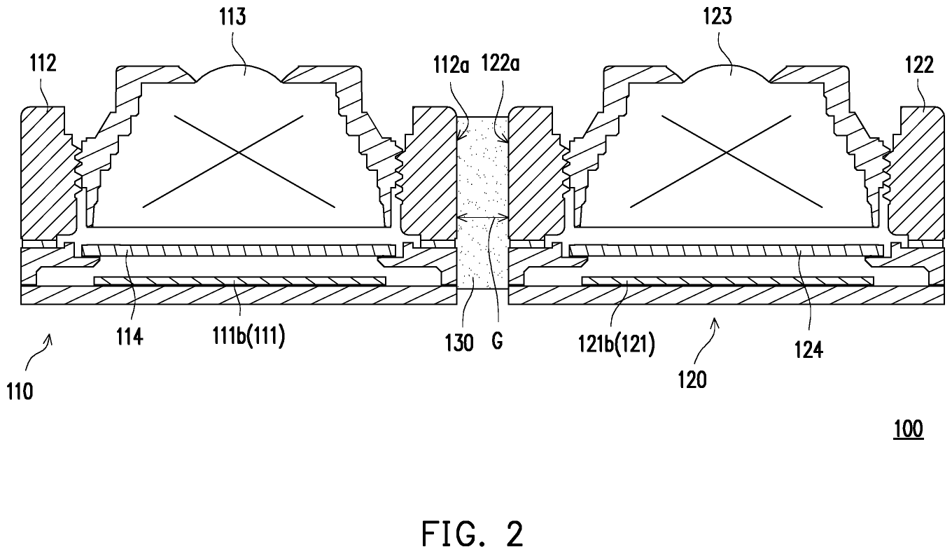

FIG. 1 is a schematic structural diagram of a dual camera module according to a first embodiment of the invention. FIG. 2 is a schematic cross-sectional diagram of the dual camera module depicted in FIG. 1 along line A-A. Referring to FIG. 1 and FIG. 2, in the present embodiment, a dual camera module 100 includes a first camera module 110, a second camera module 120 and a glue 130. The first camera module 110 and the second camera module 120 are arranged side by side, and a relative position between the first camera module 110 and the second camera module 120 is fixed by the glue 130.

The first camera module 110 includes a first circuit board 111, a first base 112, a first lens 113 and a first photosensitive element 114, wherein the first lens 113 and the first photosensitive element 114 are both disposed inside the first base 112, and the first base 112 is disposed on the first circuit board 111. Furthermore, the first circuit board 111 has a first section 111a exposed from the first base 112 and a second section 111b extending into the first base 112, wherein the first photosensitive element 114 is disposed on the second section 111b, and the first photosensitive element 114 is located between the first lens 113 and the second section 111b.

The second camera module 120 includes a second circuit board 121, a second base 122, a second lens 123 and a second photosensitive element 124, wherein the second lens 123 and the second photosensitive element 124 are both disposed inside the second base 122, and the second base 122 is disposed on the second circuit board 121. Furthermore, the second circuit board 121 has a first section 121a exposed from the second base 122 and a second section 121b extending into the second base 122, wherein the second photosensitive element 124 is disposed on the second section 121b, and the second photosensitive element 124 is located between the second lens 123 and the second section 121b.

In the present embodiment, the first circuit board 111 and the second circuit board 121 are arranged side by side, and the first base 112 and the second base 122 are arranged side by side. Furthermore, the first base 112 has a first outer surface 112a, and the second base 122 has a second outer surface 122a. The first outer surface 112a and the second outer surface 122a face to each other. For example, the first outer surface 112a and the second outer surface 122a overlap with each other in a direction perpendicular to the first outer surface 112a or the second outer surface 122a. The glue 130 is filled in a gap G between the first outer surface 112a and the second outer surface 122a and adhered to the first outer surface 112a and the second outer surface 122a, so as to fix the relative position between the first camera module 110 and the second camera module 120. On the other hand, the gap G between the first outer surface 112a and the second outer surface 122a may be less than or equal to 12 millimeters (mm).

To continue, in a condition that the relative position between the first camera module 110 and the second camera module 120 is fixed by the glue 130, the relative position between the first camera module 110 and the second camera module 120 may be prevented from deviating. Second, by fixing the relative position between the first camera module 110 and the second camera module 120 by the glue 130, not only the manufacturing cost may be low, but also the gap G between the first outer surface 112a and the second outer surface 122a may be less than or equal to 12 mm, which contributes to the development of a terminal device toward miniaturization.

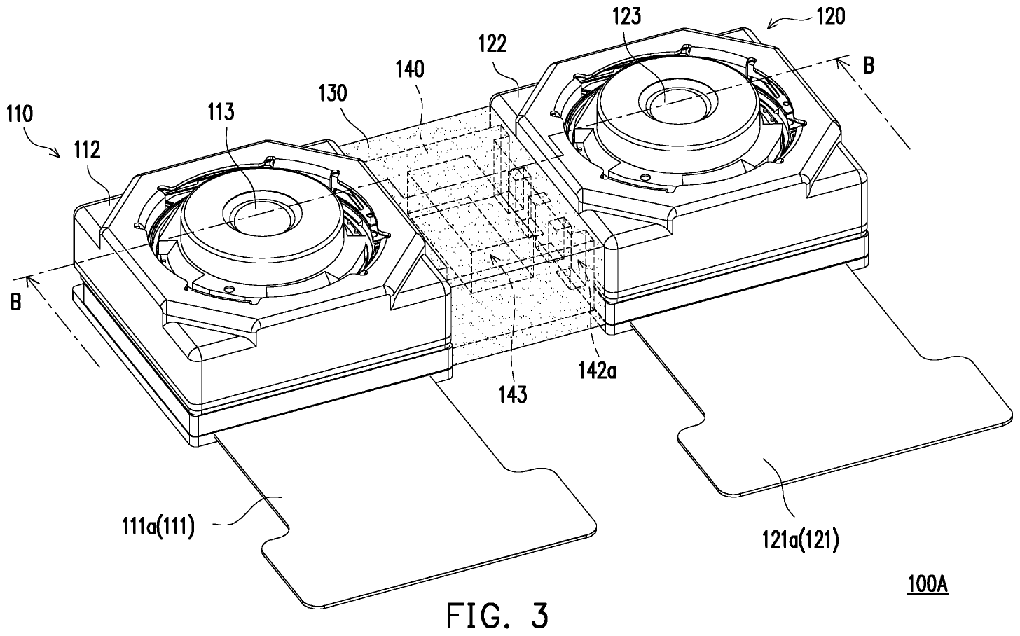

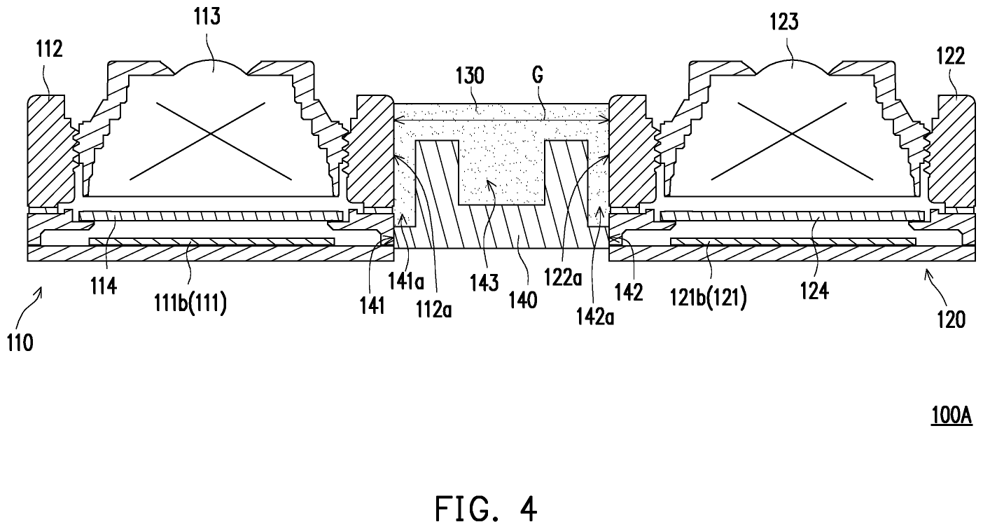

FIG. 3 is a schematic structural diagram of a dual camera module according to a second embodiment of the invention. FIG. 4 is a schematic cross-sectional diagram of the dual camera module depicted in FIG. 3 along line B-B. Referring to FIG. 3 and FIG. 4, in the present embodiment, a dual camera module 100A is different from the dual camera module 100 of the first embodiment, and the difference between the two will be described as follows. The dual camera module 100A further includes a support 140 disposed in the gap G between the first outer surface 112a and the second outer surface 122a. The support 140 has a first side surface 141 and a second side surface 142 opposite to each other, wherein the first side surface 141 abuts against the first outer surface 112a and the second side surface 142 abuts against the second outer surface 122a. On the other hand, the glue 130 is not only adhered to the first outer surface 112a and the second outer surface 122a, but further covers at least a part of the support 140, thereby improving the bonding strength as the gluing area is increased.

At least one trench may be disposed on the first side surface 141 or the second side surface 142 of the support 140, and in the present embodiment, the first side surface 141 and the second side surface 142 which are respectively disposed with the trenches are taken as an example for description, but the invention is limited thereto. Specifically, the first side surface 141 is disposed with first trenches 141a, and the second side surface 142 is disposed with second trenches 142a. The first trenches 141a and the second trenches 142a may have the same number and are symmetrically disposed on two opposite sides of the support 140, but the invention is not limited thereto. In other embodiments, the number of the first trenches may be greater than or less than the number of the second trenches.

In the present embodiment, the first side surface 141 and the first trenches 141a thereon face the first outer surface 112a, and the second side surface 142 and the second trenches 142a thereon face the second outer surface 122a. At least a part of the glue 130 is filled in the first trenches 141a and adhered to the first outer surface 112a, and at least a part of the glue 130 is filled in the second trenches 142a and adhered to the first outer surface 112a, thereby improving the bonding strength as the gluing area is increased. On other hand, the support 140 further has a third trench 143 located between the first side surface 141 and the second side surface 142. Furthermore, the first trenches 141a and the second trenches 142a are respectively located at two opposite sides of the third trench 143, without communicating with the third trench 143. At least a part of the glue 130 is filled in the third trench 143, thereby improving the bonding strength as the gluing area is increased.

To continue, by disposing the support 140 disposed with the trenches in the gap G between the first outer surface 112a and the second outer surface 122a, not only a positioning support effect may be obtained to prevent the relative position between the first camera module 110 and the second camera module 120 from deviating, but also the bonding strength among the glue 130, the support 140, the first camera module 110 and the second camera module 120 may be improved.

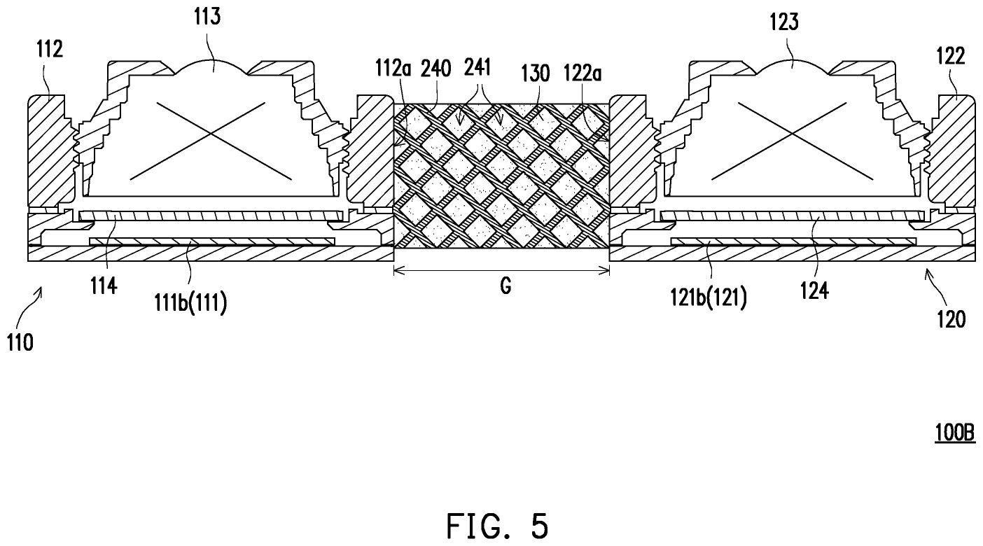

FIG. 5 is a schematic cross-sectional diagram of a dual camera module according to a third embodiment of the invention. Referring to FIG. 5, the main difference between a dual camera module 100B of the present embodiment and the dual camera module 100A of the second embodiment lies in the structural type of the support. Furthermore, a support 240 in the dual camera module 100B has a plurality of holes 241, and at least a part of the glue 130 is filled in the holes 241, thereby improving the bonding strength as the gluing area is increased.

Based on the above, the dual camera module of the invention is a frameless dual camera module, in which the two camera modules are adhered together by the glue to fix the relative position between the two camera modules, thereby preventing the relative position between the two lens modules from deviating. Thus, the dual camera module of the invention can not only have low manufacturing cost, but also contribute to the development of the terminal device toward miniaturization. On the other hand, by disposing the support disposed with the trenches or the holes between the two camera modules, not only the positioning support effect can be obtained to prevent the relative position between the two camera modules from deviating, but also the bonding strength among the glue, the support and the two camera modules can be improved.

Although the present invention has been described with reference to the embodiments thereof, it will be apparent to one of the ordinary skills in the art that modifications to the described embodiments may be made without departing from the spirit of the invention. Accordingly, the scope of the invention will be defined by the attached claims not by the above detailed description.

What is claimed is:

1. A dual camera module, comprising:
a first circuit board;
a second circuit board, arranged side by side with the first circuit board;
a first base, disposed on the first circuit board;
a first lens, disposed inside the first base;
a second base, disposed on the second circuit board, wherein the second base and the first base are arranged side by side, and a first outer surface of the first base faces a second outer surface of the second base;
a second lens, disposed inside the second base; and
a glue, disposed between the first base and the second base and adhered to the first outer surface and the second outer surface.

2. The dual camera module as recited in claim 1, further comprising:
a support, disposed between the first lens and the second lens, wherein the support has a first side surface and a second side surface opposite to each other, the first side surface abuts against the first outer surface and the second side surface abuts against the second outer surface, and the glue covers at least a part of the support.

3. The dual camera module as recited in claim 2, wherein the first side surface of the support is disposed with at least one trench, the trench faces the first outer surface, and at least a part of the glue is filled in the trench and adhered to the first outer surface.

4. The dual camera module as recited in claim 2, wherein the second side surface of the support is disposed with at least one trench, the trench faces the second outer surface, and at least a part of the glue is filled in the trench and adhered to the second outer surface.

5. The dual camera module as recited in claim 2, wherein the support further has at least one trench located between the first side surface and the second side surface, and at least a part of the glue is filled in the trench.

6. The dual camera module as recited in claim 2, wherein the support has a plurality of holes, and at least a part of the glue is filled in the holes.

7. The dual camera module as recited in claim 1, wherein a gap between the first outer surface of the first base and the second outer surface of the second base is less than or equal to 12 millimeters (mm).

8. The dual camera module as recited in claim 1, further comprising:
a first photosensitive element, disposed on the first circuit board, disposed inside the first base and located between the first lens and the first circuit board; and
a second photosensitive element, disposed on the second circuit board, disposed inside the second base and located between the second lens and the second circuit board.
